(19) United States
(12) Patent Application Publication
(10) Pub. No.: US 2025/0266973 A1
(43) Pub. Date: Aug. 21, 2025

(54) SYSTEMS AND METHODS OF LATENCY REDUCTION

(71) Applicant: Meta Platforms Technologies, LLC, Menlo Park, CA (US)

(72) Inventors: Madhusudan Kinthada Venkata, South San Diego, CA (US); Manjinder Sandhu, San Diego, CA (US)

(73) Assignee: Meta Platforms Technologies, LLC, Menlo Park, CA (US)

(21) Appl. No.: 19/031,262

(22) Filed: Jan. 17, 2025

Related U.S. Application Data
(60) Provisional application No. 63/554,188, filed on Feb. 16, 2024.

(51) Int. Cl. H04L 5/00; H04L 1/08; H04W 4/029; H04W 28/02

(52) U.S. Cl. CPC H04L 5/0094; H04L 1/08; H04W 4/029; H04W 28/0268

(57) ABSTRACT

Systems and methods of low latency communication may include receiving, by a communication device, a grant from a wireless communication node, defining a plurality of sub-frames in which to transmit one or more data packets. The communication device may generate, for a data packet, a plurality of duplicate packets of the data packet. The communication device may transmit, in successive sub-frames of the plurality of sub-frames, a respective packet from the data packet and the plurality of duplicate packets.

### CROSS REFERENCE TO RELATED PATENT APPLICATIONS

This application claims priority to U.S. Provisional Patent Application No. 63/554,188 filed Feb. 16, 2024, which is incorporated by reference herein in its entirety for all purposes.

### FIELD OF DISCLOSURE

The present disclosure is generally related to wireless communication, including but not limited to, systems and methods for latency reduction.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure is directed to a method. The method may include receiving, by a communication device, a grant from a wireless communication node, defining a plurality of sub-frames in which to transmit one or more data packets. The method may include generating, by the communication device, for a data packet, a plurality of duplicate packets of the data packet. The method may include transmitting, by the communication device, in successive sub-frames of the plurality of sub-frames, a respective packet from the data packet and the plurality of duplicate packets.

In some embodiments, the method includes determining, by the communication device, to generate the plurality of duplicate packets based on a network condition of the communication device satisfying a selection criterion. In some embodiments, the network condition includes at least one of a count of negative acknowledgements received from the wireless communication node, a received signal strength, or a throughput. In some embodiments, the method includes determining, by the communication device, to generate the plurality of duplicate packets, based on at least one of a condition of the communication device or one or more services supported by the communication device.

In some embodiments, the condition of the communication device includes at least one of a location of the device or a movement metric of the communication device. In some embodiments, the one or more services correspond to generation of latency-sensitive traffic for transmission by the communication device to the wireless communication node. In some embodiments, the method includes receiving, by the communication device from the wireless communication node, for one of the respective packets, an acknowledgement or negative acknowledgement, wherein the acknowledgement or the negative acknowledgement corresponds to the data packet.

In some embodiments, the method includes generating, by the communication device, for a plurality of data packets including the data packet, a plurality of respective duplicate packets for each of the plurality of data packets. The method may further include transmitting, by the communication device, in the successive sub-frames of the plurality of sub-frames, respective packets from the plurality of data packets and the plurality of respective duplicate packets.

In some embodiments, the method includes receiving, by the communication device from the wireless communication node, for one of the respective packets, a respective acknowledgement or negative acknowledgement, wherein the respective acknowledgement or the negative acknowledgement corresponds to the data packet of the plurality of data packets. In some embodiments, the respective acknowledgement or negative acknowledgement for the plurality of data packets is received in a plurality of second sub-frames subsequent to the plurality of first sub-frames. In some embodiments, the respective acknowledgement or negative acknowledgement for the plurality of data packets is received in a single sub-frame subsequent to the plurality of sub-frames. In some embodiments, the grant includes at least one of a downlink grant or an uplink grant.

In another aspect, this disclosure is directed to a wireless communication endpoint. The endpoint may be configured to receive a grant from a wireless communication node, defining a plurality of sub-frames in which to transmit one or more data packets. The endpoint may be configured to generate, for a data packet, a plurality of duplicate packets of the data packet. The endpoint may be configured to transmit, in successive sub-frames of the plurality of sub-frames, a respective packet from the data packet and the plurality of duplicate packets.

In some embodiments, the endpoint is configured to determine to generate the plurality of duplicate packets, based on a network condition of the communication device satisfying a selection criterion, wherein the network condition includes at least one of a count of negative acknowledgements received from the wireless communication node, a received signal strength, or a throughput. In some embodiments, the endpoint is configured to determine to generate the plurality of duplicate packets, based on at least one of a condition of the communication device or one or more services supported by the communication device, wherein the condition of the communication device includes at least one of a location of the communication device or a movement metric of the communication device, and wherein the one or more services correspond to generation of latency-sensitive traffic for transmission by the communication device to the wireless communication node.

In some embodiments, the endpoint is configured to receive, from the wireless communication node, for one of the respective packets, an acknowledgement or negative acknowledgement, wherein the acknowledgement or the negative acknowledgement corresponds to the data packet. In some embodiments, the endpoint is configured to generate, for a plurality of data packets including the data packet, a plurality of respective duplicate packets for each of the plurality of data packets; and transmit in the successive sub-frames of the plurality of sub-frames, respective packets from the plurality of data packets and the plurality of respective duplicate packets. In some embodiments, the endpoint is configured to receive, from the wireless communication node, for one of the respective packets, a respective acknowledgement or negative acknowledgement, wherein the respective acknowledgement or the negative acknowledgement corresponds to the data packet of the plurality of data packets, wherein the plurality of sub-frames include a plurality of first sub-frames, and the respective acknowledgement or negative acknowledgement for the plurality of data packets is received in a plurality of second sub-frames subsequent to the plurality of first sub-frames, or wherein the respective acknowledgement or negative acknowledgement for the plurality of data packets is received in a single sub-frame subsequent to the plurality of sub-frames. In some aspects, the techniques described herein relate to a wireless communication endpoint, wherein the grant includes at least one of a downlink grant or an uplink grant.

In another aspect, this disclosure is directed to a non-transitory computer readable medium storing instructions that, when executed by one or more processors, cause the one or more processors to receive a grant from a wireless communication node, defining a plurality of sub-frames in which to transmit one or more data packets; generate, for a data packet, a plurality of duplicate packets of the data packet; and transmit, in successive sub-frames of the plurality of sub-frames, a respective packet from the data packet and the plurality of duplicate packets.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a computing environment, according to an example implementation of the present disclosure.

FIG. 6 is a sub-frame diagram for uplink communication, according to an example implementation of the present disclosure.

FIG. 7 is a sub-frame diagram for downlink communication, according to an example implementation of the present disclosure.

FIG. 8 is another sub-frame diagram for uplink communication, according to an example implementation of the present disclosure.

FIG. 9 is another sub-frame diagram for downlink communication, according to an example implementation of the present disclosure.

FIG. 10 is a flowchart showing an example method of uplink communication, according to an example implementation of the present disclosure.

FIG. 11 is a flowchart showing an example method of downlink communication, according to an example implementation of the present disclosure.

FIG. 12 is a flowchart showing an example method, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

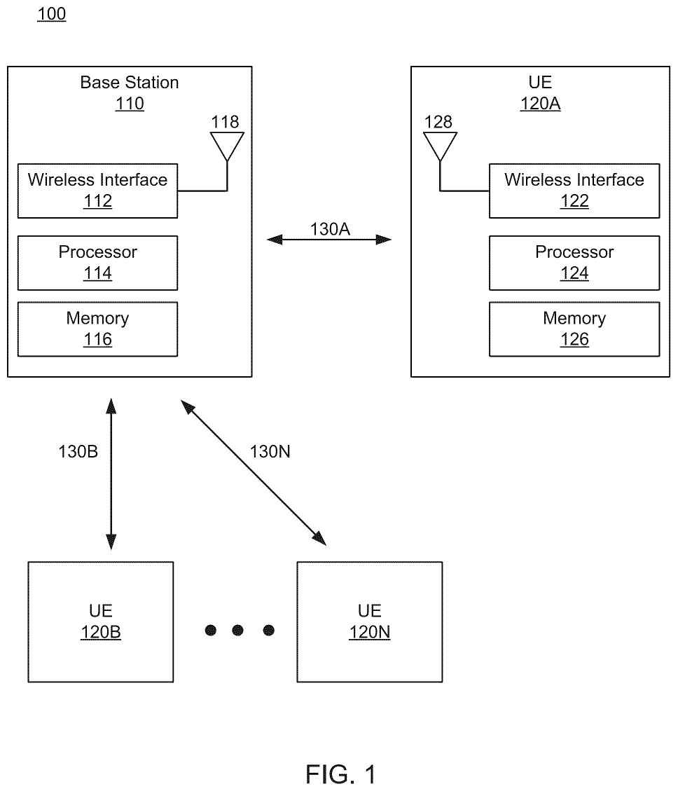

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random-access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

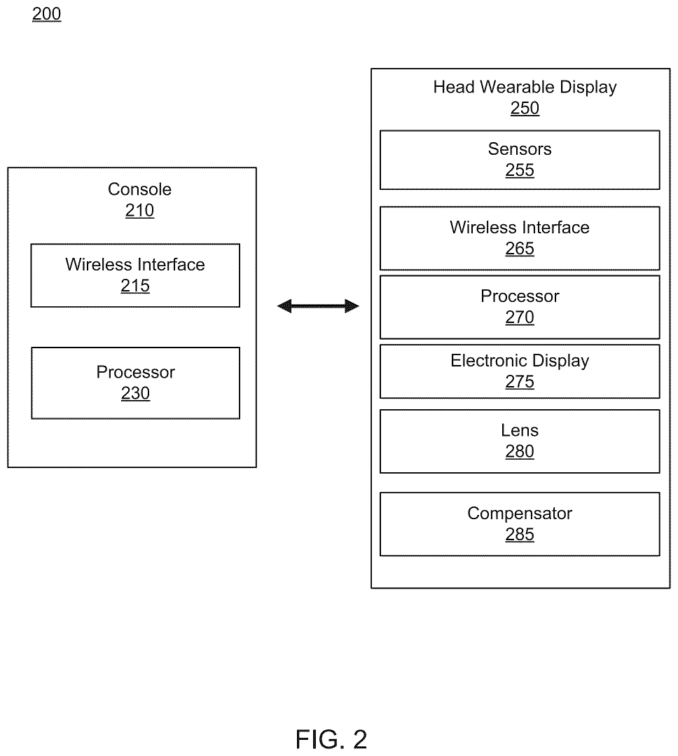

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD), or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

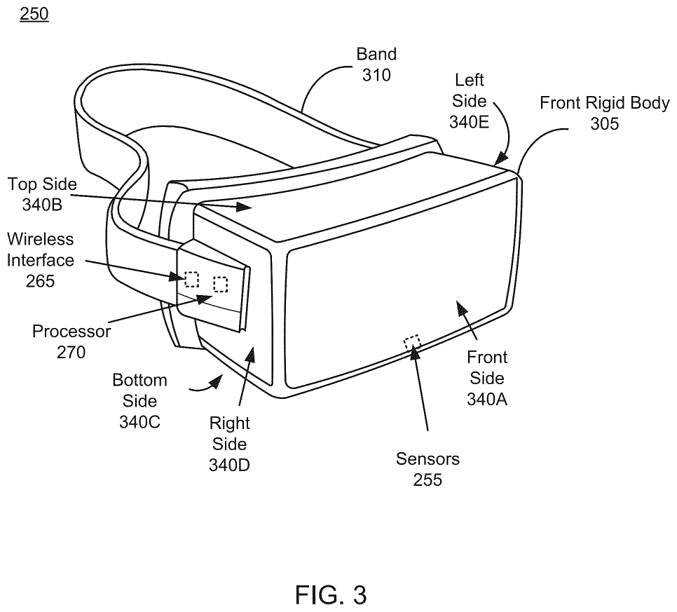

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

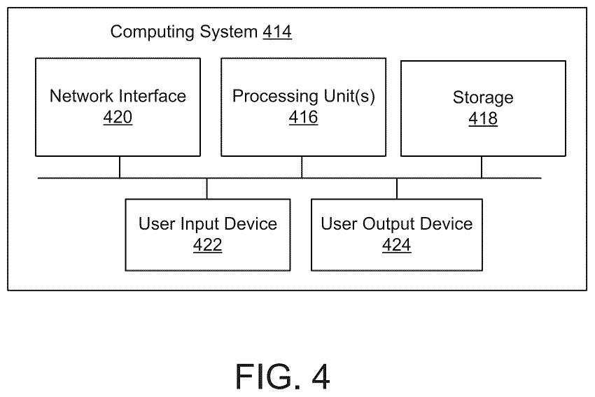

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHZ, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

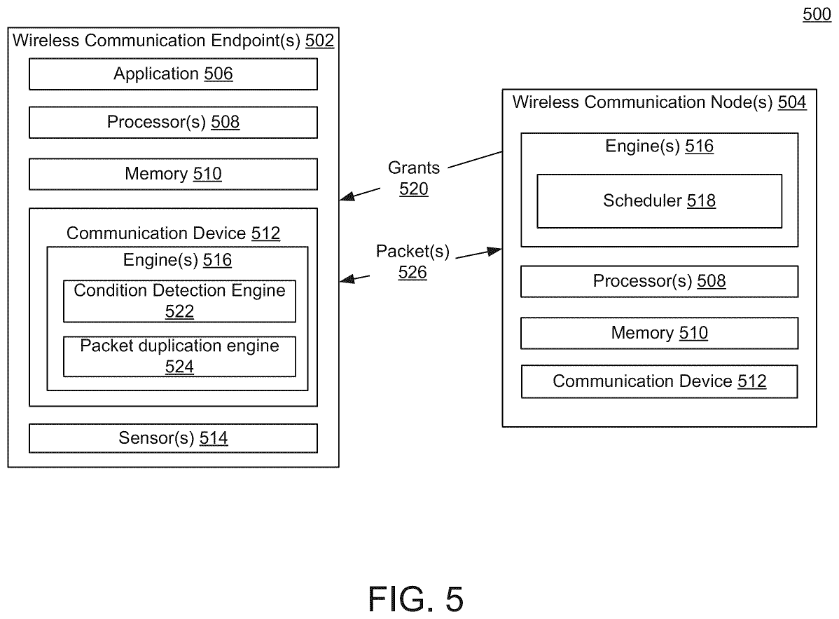

Referring generally to FIG. 5-FIG. 11, this disclosure relates to systems and methods for latency reduction. In particular, the systems and methods described herein may provide latency reduction for various applications including time critical extended reality (XR) (e.g., virtual reality (VR), mixed reality (MR), and/or augmented reality (AR)) traffic. In various embodiments, the systems and methods described herein may be applicable in various cellular technologies, such as 4G and 5G cellular technologies. For example, cellular technologies which do not support mini-slots or self-contained slot features may benefit from the present disclosure when used in conjunction with latency-sensitive applications.

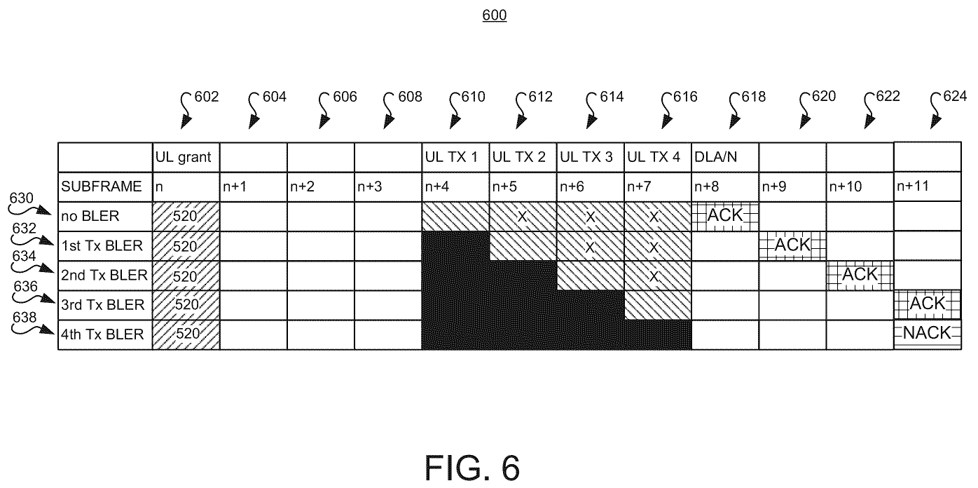

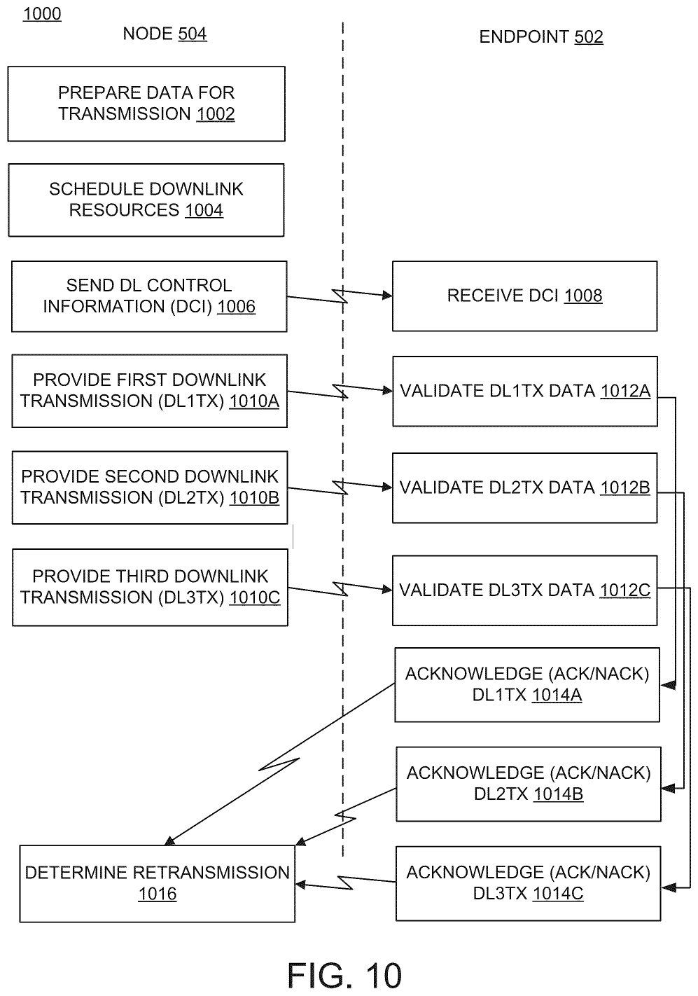

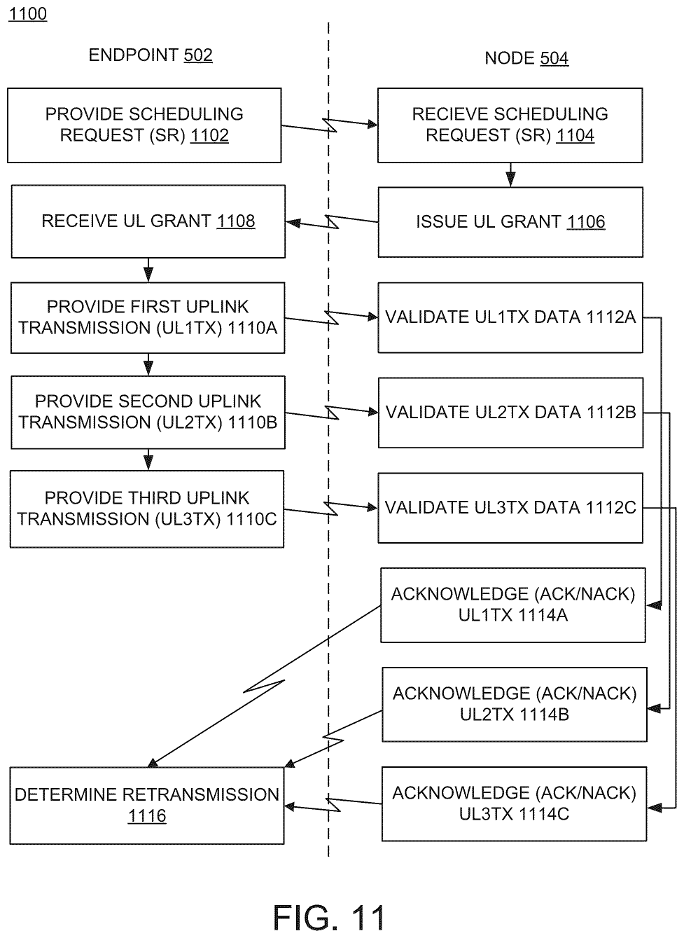

According to the systems and methods described herein, a device may be configured to perform multiple repeated transmissions of packets for sub-frames of uplink (UL), or downlink (DL) granted frames, across various slots (e.g., consecutive sub-frames) of a cellular or other network. For example, within the context of UL grants, a device may have one or more transmissions to send UL to an endpoint. In various embodiments, the device may transmit each of the one or more UL transmissions (e.g., packets) within a first sub-frame, and then (e.g., in a subsequent sub-frame), repeat the same UL transmissions (e.g., packets) multiple times. For example, FIG. 6-FIG. 9 depict examples including four repeated transmission and FIG. 10 and FIG. 11 depict examples including three repeated transmissions, though any number of repeated transmissions may be performed. In some embodiments, the device can sequence the various multiple transmissions, so that repeated transmissions of a first transmission are transmitted prior to a transmission of a second transmission.

Repeating transmissions prior to a receipt of a positive acknowledgement (ACK) or negative acknowledgement (NACK) can reduce a delay for any one of the transmissions as compared to other solutions. For example, when communicating over a lossy medium, if a first packet is received with uncorrectable errors, latency can be incurred according to a delay while a receiving device conducts a verification step, such as a cyclic redundancy check (CRC), or otherwise processes the received packet. Such a delay can extend even further where no received packet is detected, such as where a timeout of a handshake process indicates a failure of the receiving device to acknowledge receipt. Further delay may be incurred while the sending device schedules a slot to re-send the same payload data or other data to aid a receiving device in decoding a previously sent packet (e.g., forward error correction [FEC] data). If this subsequent packet is not received or positively acknowledged, additional latency may accumulate according to its processing and retransmission.

By sending duplicate packets in advance of receiving a negative acknowledgement from a target device for the transmission, this latency can be reduced. For example, by providing three or four duplicate copies of the same packet, delays associated with retransmission can be obviated, even where two or three of the respective packets are non-decodable by a receiving device. References to duplicate packets should be understood as referring to a packet having a same payload data. Each of the duplicate packets may (but need not) include distinct sequence numbers, timestamps, or other non-duplicate indicia. Moreover, duplicated packets can be substituted for redundancy data in some embodiments. A receiving device can use the non-duplicate indicia to determine a status of a communications channel. For example, where a receiving device receives three duplicate packets having sequence numbers of 0x0001, 0x0003, and 0x0007, the receiving device can infer a relatively lossy communications medium. Conversely, a receiving device receiving three duplicate packets having sequence numbers of 0x0008, 0x0009, and 0x000A can infer a relatively reliable medium. Indeed, various aspects of the packet duplication and verification can be performed at a physical layer (PHY) or data link layer of a device, as may be performed transparently, to other layers of a stack. Accordingly, from an application or other layer, the transmission and receipt of duplicate packets can be executed transparently.

Because duplicate transmissions may extend active times for transmitting or receiving radios, as may increase network congestion, power usage, or thermal loading, it may be advantageous to adjust a quantity of duplicate packets transmitted based on a detected condition. For example, for an expected packet error rate (PER) of five hundred packets per million, no duplicated packets may be transmitted, while for an expected packet error rate of five percent, several duplicated packets can be transmitted. A detected condition can, but need not refer to a state of a network as may be based on a historical PER, bit error rate (BER), or other Quality of Service (QOS) metric. For example, a detected condition can include a speed of a cellular device, received signal strength indicator (RSSI), or other data which is predictive of a PER or other block level error rate (BLER). Further, a quantity of duplicate packets can be adjusted based on a type of traffic or device. For example, some data transfers (e.g., latency sensitive data) can include several duplicate copies, even for a PER of five hundred packets per million, while other data transfers (e.g., bulk data transfers or applications with application-level redundancy) can omit duplicated packets, even where a PER exceeds five or ten percent.

Referring to FIG. 5, a block diagram of a system 500 for low latency communication is provided according to an example implementation of the present disclosure. The system 500 may include elements, hardware, or components similar to those described above with reference to FIG. 1-FIG. 4. For example, the system 500 may include one or more wireless communication endpoints 502 (referred to generally as endpoint(s) 502 or endpoint 502) and one or more wireless communication nodes 504. The endpoint(s) 502 may be similar to the user equipment 120, console 210, and/or head wearable display 250 described above with reference to FIG. 1-FIG. 4, and/or an application server which is hosting one or more resources/services/applications 506 executable by the endpoint(s) 502. In other words, and in various embodiments, the endpoint(s) 502 may be or include an application server and/or user equipment (e.g., in a peer-to-peer communication session and/or in communication with an application server). The wireless communication node(s) 504 may be, include, or be similar to the base station 110 described above with reference to FIG. 1.

The endpoint(s) 502 and wireless communication node(s) 504 may include respective processor(s) 508, memory 510, communication device(s) 512. The processor(s) 508 may be the same as or similar to the processors 114, 124, 230, 270 and/or processing unit(s) 416 described above with reference to FIG. 1-FIG. 4. The memory 510 may be the same as or similar to memory 116, 126, and/or storage 418 described above with reference to FIG. 1-FIG. 4. The communication device 512 may be the same as or similar to the wireless interface 112, 122, 215, 265 (e.g., in combination with or communicably coupled to antenna 118, 128) and/or network interface 420 described above with reference to FIG. 1-FIG. 4. The sensors 514 may be the same as or similar to the sensors 255 of FIG. 1-FIG. 4.

The communications devices of the endpoint(s) (502 and wireless communication node(s)) 504 may include various processing engine(s) 516. Some examples of engines 516 are depicted as coupled with or constituent to the communications device 512 of the endpoint 502 and the wireless communication node 504. The processing engine(s) 516 may be or include any device, component, element, or hardware designed or configured to perform one or more of the functions described herein. For example, the wireless communication node(s) 504 may include a scheduler 518 configured to schedule one or more resource grants 520 (referred to generally as grants 520). The grants 520 can refer to an allocation of an uplink or downlink channel, and may include a Physical Uplink Shared Channel (PUSCH), Physical Downlink Shared Channel (PDSCH), broadcast channels, control channels, or otherwise correspond to a communications medium coupling the endpoint 502 with the wireless communication node 504.

The endpoint(s) 502 may include a condition detection engine 522 and a packet duplication engine 524. While certain processing engine(s) 516 are shown and described herein, it should be understood that additional and/or alternative processing engine(s) 516 may be implemented on the endpoint(s) 502 and/or wireless communication node(s) 504. Additionally, two or more of the processing engine(s) 516 may be implemented as a single processing engine 516. Furthermore, one of the processing engine(s) 516 may implemented as multiple processing engines 516. Moreover, the wireless communication node(s) 504 can include engines 516 depicted as engines 516 of the endpoint(s) 502 and the endpoint(s) can include engines 516 depicted as engines 516 of the wireless communication node(s) 504. For example, the depicted wireless communications node 504 can include a condition detection engine 522 and packet duplication engine 524 (e.g., to implement aspects of the present disclosure for bidirectional communication). In some embodiments, the engines 516 of the endpoint(s) 502 or wireless communication node(s) 504 operate locally. In some embodiments, engines 516 of the endpoint(s) 502 or wireless communication node(s) 504 operate in conjunction with one another (e.g., according to a leader-follower configuration).

As described in greater detail below, the condition detection engine 522 may be configured to determine, identify, or otherwise estimate a condition related to a communicative connection between communications devices 512, such as a condition of a communications medium therebetween. The packet duplication engine 524 may be configured to duplicate packets received for transmission to the wireless communications node 504, or manage a receipt of duplicate packets as received from the wireless communications node 504. Inversely, when implemented on the wireless communications node 504, the packet duplication engine 524 may be configured to duplicate packets received for transmission to the endpoint 502, or manage a receipt of duplicate packets as received from the endpoint 502.

As shown in FIG. 5, the endpoint 502 may include an application 506. While shown as being included on the endpoint 502, in various embodiments, the application 506 may in some embodiments at least partially execute on a paired device. For example, the endpoint 502 may be or include the console 210 of FIG. 2, and the application 506 may be at least partially executed on the head wearable display 250 of FIG. 2. The application 506 may be or include any type or form of application, resource, or service executable on the endpoint 502 which may involve generation of and transmission to, or receipt from and consumption by, data between the endpoint 502 and another endpoint 502 using the wireless communication node(s) 504. For example, the application 506 may be or include an extended reality (XR) application, video/audio call or conferencing application, gaming application, and so forth. Each endpoint 502 or wireless communication node 504 can include any number of applications 506, as may communicate with any further number of endpoint(s) 502 or wireless communication node(s) 504.

Where execution of the application 506 involves generation of data for transmission to another endpoint 502 (e.g., via the communication device 512), the endpoint 502 may be configured to request a scheduling grant from a wireless communication node 504 (e.g., by transmitting a scheduling request to the wireless communication node 504). The scheduling request may be or include an uplink control message generated by the communication device 512 of the endpoint 502. This scheduling request may include, carry, identify, otherwise provide various information relating to the requested grants, such as a Buffer Status Report (BSR), traffic patterns corresponding to traffic which is to be sent according to the grants 520, information about the priority of the data, QoS requirements associated with the application 506, and/or timing constraints. Further, applications 506 instantiated at least in part by the wireless communication node 504 can access the schedule to schedule downlink communication using a local control message generated by the communication device 512 of the wireless communication node 504.

The wireless communication node 504 may include a scheduler 518. The scheduler 518 may be designed or configured to select, determine, or otherwise configure one or more grants 520 to an endpoint 502 or other communication device 512. For example, the scheduler 518 can determine a grant 520 based on a scheduling requests received from various endpoints 502 served by the wireless communication node 504. In particular, the scheduler 518 may configure the grants 520 to respective communication devices 512 of the endpoints 502 (e.g., at the physical layer of the endpoints 502), according to the scheduling requests.

The grants 520 can be generated responsive to a scheduling request received from the endpoint 502 or a locally generated scheduling request (e.g., for wireless communication node 504 initiated downlink communication). The grants 520 may be or include resource allocations provided by the wireless communication node 504 to the endpoint 502. The grants 520 may indicate, identify, configure, or otherwise specify usage by the endpoint 502 of radio resources for communication, such as frequency resources (e.g., specific frequencies or sub-carriers), time resources (e.g., time slots or sub-frames), transmission power levels, Modulation and Coding Scheme (MCS), retransmission protocols (e.g., hybrid automatic repeat request (HARQ) processes), and/or QoS parameters. The grants 520 can include downlink control information (DCI).

The grants 520 may be or include different types or forms of grants, depending on the scheduling request from the endpoint(s) 502. For example, the grants 520 may include configured grants 520, dynamic grants 520, and/or semi-persistent scheduling grants 520. The scheduler 518 may be configured to determine the type of grant 520, based on the scheduling requests generated locally or received from the endpoint 502 and/or whether the scheduling request is for downlink or uplink traffic. For example, for a scheduling request indicating sporadic data traffic or a buffer overflow, the scheduler 518 may be configured to select a dynamic grant for the endpoint 502 to address immediate transmission needs. As another example, for the scheduling request tied to an application 506 that transmits uplink (or downlink) data periodically, the scheduler 518 may select a configured grant to provide for regular uplink transmissions without repetitive scheduling requests. Similarly, for a scheduling request relating to recurring downlink traffic, such as video streaming or voice calls, the scheduler 518 may select a semi-persistent scheduling grant.

As indicated above, the condition detection engine 522 may be configured to determine, identify, or otherwise estimate a condition related to a communicative connection between the endpoint 502 and the wireless communication node 504. In some embodiments, the condition detection engine 522 is configured to detect a condition based on an input received from a sensor 514. The sensor 514 can include an accelerometer, global positioning system (GPS) sensor, barometer, or other sensor 514 operatively coupled with the condition detection engine 522. For example, the condition detection engine 522 can detect a speed or positioning, as may be indicative of a location, relative location, or speed of a communication device (e.g., an endpoint 502 relative to a wireless network node 504). That is, accordingly, the condition detected by the condition detection engine 522 can include a condition of the communication device including at least one of a location of the communication device or a movement metric of the communication device. For example, the location can be indicative of a geofenced region indicative of a quantity of duplicate packets to be provided, or a relative location or speed as may be indicative of a BLER (e.g., and an increased number of duplicated packets). The sensor 514 can include a battery sensor 514 or thermal sensor 514 operatively coupled with the condition detection engine 522. For example, the condition detection engine 522 can detect a condition of low battery or high temperature, as may be indicative of reducing transmit power (e.g., omitting fewer or any duplicate packets).

In some embodiments, the sensor 514 includes a radio/antenna, transmit/receive (TX/RX) chain, or other radio component of the communication device 512. For example, the sensor 514 can include CRC generation components configured to determine a packet error rate for incoming or outgoing packets, a signal strength (e.g., RSSI) for incoming or outgoing packets, or other aspects of wireless communication. The condition detection engine 522 can determine a network condition of a communication device using such a sensor 514, as may satisfy a condition of the packet duplication engine 524 related to a quantity of duplicate packets.

The network condition can include at least one of a count of negative acknowledgements received from the wireless communication device, a signal strength (e.g., RSSI), or a throughput (e.g., a number of packets successfully sent or received per unit time). For example, the condition detection engine 522 can maintain a counter for a number of packets. The count may be incremented responsive to the receipt of negative acknowledgements or other triggers and reduced based on a passage of time, a number of positive acknowledgements, or other triggers. The condition detection engine 522 can determine a selection criterion based on a condition of a device. The condition of the device can include a battery condition, temperature, or configuration. The condition of the device can include one or more services supported by the device, or another device communicatively coupled therewith. For example, the condition can include a support for providing or acknowledging the duplicate packets. A service can include a service associated with a generation of latency-sensitive traffic for transmission by the communication device to the wireless communication node 504, such as a XR service.

As indicated above, the packet duplication engine 524 may be configured to generate duplicate instances of packets received for transmission or manage a receipt or acknowledgement of duplicated packets as received. The packet duplication engine 524 can be configured to determine a quantity of duplicate packets to include in a sequence of sub-frames. The packet duplication engine 524 can determine the quantity of packets using selection criterion detected or determined by the condition detection engine 522. For example, the packet duplication engine 524 can compare a condition detected by the condition detection engine 522 to a threshold corresponding to a quantity of packets. In some embodiments, the packet duplication engine 524 is configured to compare a condition to multiple thresholds (e.g., thresholds for no duplicate packets, one, two, or three duplicate packets, or so on).

In some embodiments, the packet duplication engine 524 is configured to compare a metric including one or more conditions. For example, the packet duplication engine 524 can determine a quantity of duplicate packets using a metric for any of a speed, distance, RSSI, battery or other device condition, historical network data (e.g., a counter state). The packet duplication engine 524 may further determine if a communicatively coupled (e.g., a counterparty device) device supports packet duplication (e.g., a flag bit or other indication, as may be provided via control channel messaging). Based on a determination that a communicatively coupled device supports packet duplication and the comparison of one or more selection criterion to a threshold, the duplication engine 524 may insert multiple packets into successive sub-frames. In some embodiments, the successive sub-frames include contiguous sub-frames. In some embodiments, the sub-frames can be substituted for slots, mini-slots, or other resource (e.g., temporally non-overlapping resource).

FIG. 6 is an example sub-frame diagram 600 for uplink communication, as provided from an endpoint device 502 to a wireless communication node 504. The diagram 600 is arranged into separate sub-frames of one or more frames. Each sub-frame may correspond to a temporal period (e.g., 1 millisecond [ms]) for a communications channel, depicted as a separate column. Each row corresponds to a separate scenario. During a first sub-frame 602, for each of the scenarios, a wireless communication node 504 provides a UL grant 520 to an endpoint 502. Subsequent to the UL grant 520, a delay can be provided so as to synchronize subsequent transmissions to the frame structure, and to allow the endpoint to decode the uplink grant 520, prepare data for transmission, and so forth. For example, as depicted, the delay can include a second sub-frame 604, third sub-frame 606, and fourth sub-frame 608. During a fifth sub-frame 610, sixth sub-frame 612, seventh sub-frame 614, and eighth sub-frame 616 for each of the scenarios, the endpoint 502 transmits duplicate copies of a packet (or redundancy data). According to other embodiments, different quantities of packets can be provided. For example, where the duplicate copies of the seventh sub-frame 614 and eighth sub-frame 616 are committed, a maximum of a 10 ms frame can be provided, where no retransmission is indicated (e.g., corresponding to the later three scenarios).

Each of the scenarios refer to a different possible decoding of the various packets. More particularly, A first row 630 corresponds to a scenario for which no uncorrectable error is present for a first instance of a packet (e.g., a packet error or other block error rate [BLER]). Subsequent instances of the packet can be sent with or without error. Accordingly, these subsequent packets may be considered as don't care (X) data for latency purposes, and a positive acknowledgment can be provided after 4 sub-frames, at the ninth sub-frame 618. However, the receiving device may analyze these packets to characterize network conditions, and provide positive or negative acknowledgements of these packets, as may aid a counterparty device to characterize a medium of the network. For example, where the communications device 512 determines that these subsequent X packets are received as uncorrectable, the communications device 512 may determine that the medium is more lossy, and where the communications device 512 validates these X packets, the communications device 512 may determine that the medium is less lossy, as may be used to modulate a number of duplicate copies for subsequent packets.

A second row 632 corresponds to a scenario for which an uncorrectable error is present for a first instance of a packet but absent for a second (duplicate) instance of the packet. As for the first row 630, subsequent instances of the packet can be sent with or without error as X data for latency purposes, and a positive acknowledgment can be provided after 4 sub-frames, at the tenth sub-frame 620. A third row 634 corresponds to a scenario for which an uncorrectable error is present for a first and second instance of a packet but absent for a third instance of the packet, and a positive acknowledgment can be provided after 4 sub-frames, at the eleventh sub-frame 622. As for the first and second rows 630, 632, subsequent instances of the packet can be sent with or without error as X data for latency purposes. A fourth row 636 corresponds to a scenario for which an uncorrectable error is present for a first, second, and third instance of a packet but absent for a fourth instance of the packet, and a positive acknowledgment can be provided after 4 sub-frames, at the twelfth sub-frame 624. As for the first, second, and third rows 630, 632, 634, subsequent instances of the packet can be sent with or without error as X data for latency purposes. In some cases, sliding frame windows may be provided such that a subsequent frame can begin upon a provision of the ACK. In some embodiments, a receiving device can NACK each of the uncorrectable duplicate packets, and the communication device 512 receiving the acknowledgement can logically OR the ACKs to determine an overall ACK for the set of duplicate packets.

For each of the first row 630, second row 632, third row 634, and fourth row 636, since at least one packet instance is received, a positive acknowledgment (ACK) is provided from the wireless communication node 504 to the endpoint 502 communication device 512, and retransmission delays (and power usage, and congestion) may thusly be avoided. However, for a particularly lossy medium, as depicted in the fifth row 638, the wireless communication node 504 does not successfully decode any of the duplicated packets upon their receipt. Accordingly, the wireless communication node 504 can provide a negative acknowledgment (NACK). The acknowledgements are depicted as provided four sub-frames following the transmission of the packets. In some contexts (e.g., long term evolution, LTE), such a period may be referred to as a Hybrid Automatic Repeat Request (HARQ) Round Trip Time (RTT).

The endpoint 502 can retransmit the packet (e.g., four or more duplicate instances) responsive to the receipt of the NACK. Although such retransmission can incur delay, such a delay is reduced relative to awaiting an acknowledgement for each transmitted packet. For example, a delay, for each packet, can extend for eight or more sub-frames (e.g., one sub-frame for packet transmission, three sub-frames for the delay subsequent to the grant 520, and the four sub-frame delay prior to the acknowledgement). Accordingly, whereas a NACK is provided at the twelfth sub-frame 624 in the depicted example, such a NACK may be provided after at least a thirty-second sub-frame, according to other approaches.

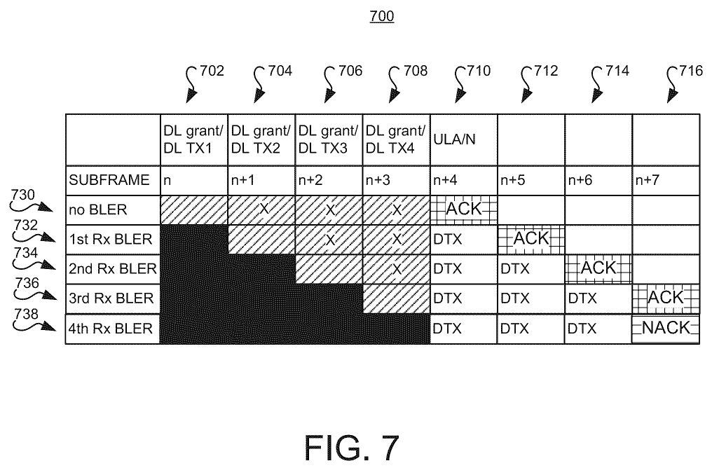

FIG. 7 is an example sub-frame diagram 700 for downlink communication as provided from to a wireless communication node 504 to a communication device 512 of an endpoint device 502. As for FIG. 6, the diagram 700 is arranged into separate sub-frames of one or more frames. Each sub-frame may correspond to a temporal period (e.g., 1 ms) for a communications channel, depicted as a separate column. Each row corresponds to a separate scenario. During a first sub-frame 702, for each of the scenarios, a wireless communication node 504 (locally) generates or schedules a DL grant 520 for transmission with an endpoint 502, and transmits a packet to the endpoint. During each of a second sub-frame 704, third sub-frame 706, and fourth sub-frame 708, the wireless communication node 504 generates or schedules a DL grant 520 for transmission with an endpoint 502, and transmits a packet duplicative of the packet of the first sub-frame 702. For example, the duplicate packets can include copies of a payload or other redundancy information.

As for the sub-frame diagram 600 of FIG. 6, each scenario corresponds to a different first successfully decoded packet. The first row 730 corresponds to a scenario in which the first packet is a first successfully decoded packet, with an ACK provided from the endpoint device 502 to a wireless communication node 504 a fixed number of sub-frames later (e.g., four, at a fifth sub-frame 710). The second row 732 corresponds to a scenario in which the second packet is a first successfully decoded packet, with an ACK provided from the endpoint device 502 to a wireless communication node 504 at a sixth sub-frame 712. The third row 734 corresponds to a scenario in which the third packet is a first successfully decoded packet, with an ACK provided from the endpoint device 502 to a wireless communication node 504 at a seventh sub-frame 714. The fourth row 736 corresponds to a scenario in which the fourth packet is a first successfully decoded packet, with an ACK provided from the endpoint device 502 to a wireless communication node 504 at an eighth sub-frame 716. The fourth row 736 corresponds to a scenario in which no packet is successfully decoded, with a NACK provided from the endpoint device 502 to a wireless communication node 504 at an eighth sub-frame 716. Responsive to the NACK, the communication device 512 of the endpoint device 502 can re-transmit one or more instances of the packet.

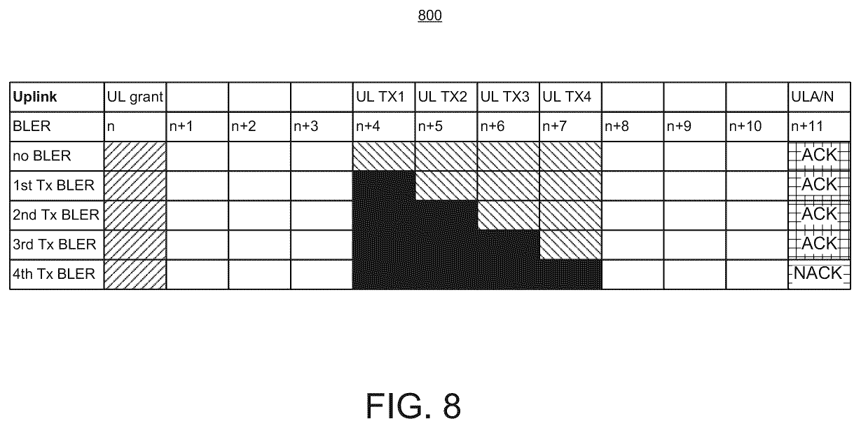

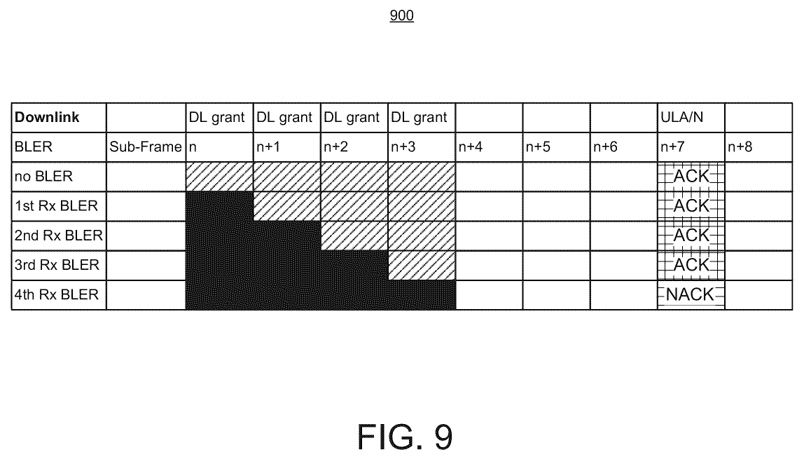

As is depicted, in some embodiments, either of an endpoint device 502 or a wireless communication node 504 can disable a radio (e.g., enter a DTX state) during periods of no communication, as may reduce energy usage and thermal load. However, a device awaiting acknowledgement for a previously transmitted packet will generally maintain a radio in an on-state, as may increase energy usage relative to other approaches. This increase in energy usage can, for example, reduce battery life. Accordingly, in some embodiments, a device can defer providing an acknowledgement until a last of a series of duplicate packets. Example sub-frame diagrams 800, 900 for such a technique are provided henceforth with regard to FIG. 8 and FIG. 9.

Referring to FIG. 8 an example sub-frame diagram 800 for uplink communication is provided. As depicted above with regard to FIG. 6, various scenarios are provided, according to various packets as may be transmitted or received. However, only a single sub-frame is provided for an ACK/NACK. Accordingly, some additional latency may be incurred in some scenarios involving relatively low BLER communication, relative to the sub-frame diagram 600 of FIG. 6. For example, relative to the first scenario of FIG. 6, an additional three ms of latency is incurred. However, such an approach can reduce power usage, by aiding a communication device 512 of a transmitting or receiving device to power-down one or more radio components (e.g., an endpoint device 502 or wireless communication node 504). Such powering down can refer to entering a sleep state, off state, or other low power state. Further, such an approach can maintain sub-frame consistency, regardless of BLER performance. Accordingly, a number of adjustments to a sliding window of a frame can be reduced, as may reduce complexity of implementation. Moreover, a sequence of successfully or unsuccessfully decoded packets does not impact an overall time to acknowledgement. For example, and of the successfully or unsuccessfully decoded packets can be re-sequenced within their respective scenarios without impacting a timing or result of the ACK, elevating the transparency provided to other layers of a network stack. In some embodiments, the ACK may be provided based on a logical OR of all packets (e.g., to indicate that at least one packet was received). In some embodiments, the ACK may be provided including a number or sequence of successfully or unsuccessfully decoded packets. Accordingly, a communication device 512 can use the number or sequence of successfully or unsuccessfully decoded packets to estimate a condition of a network, as may be useful to a condition detection engine 522 to determine a network condition.

FIG. 9 depicts example sub-frame diagram 900 for downlink communication. As depicted above with regard to FIG. 7, various scenarios are provided, according to various packets as may be transmitted or received. As described above, with regard to FIG. 8, an acknowledgment is provided at a predefined sub-frame as may reduce sliding window complexity, power usage, and so forth.

Referring now to FIG. 10, a flowchart showing an example method of uplink communication is provided, according to an example implementation of the present disclosure. Corresponding portions of the method 1000 may be executed, performed, or otherwise implemented on or related to corresponding communication devices 512 (e.g., a communication device 512 of an endpoint 502 and a communication device of a wireless communication nodes 504). Accordingly, the depicted method 1000 may be described as a first method executed, performed, or otherwise implemented by an endpoint 502 (e.g., a communication device 512 thereof), and a second method executed, performed, or otherwise implemented by a wireless communication node 504 (e.g., a communication device 512 or scheduler 518 thereof).

As a brief overview, a method executed by a first communication device 512 (e.g., the endpoint 502) includes, at step 1008, receiving DCI information or other scheduling data, determining a validity of multiple instances of a packet at step 1012, as performed prior to providing an acknowledgement, and transmitting the acknowledgement of a receipt of at least one of the packets at step 1014.

As a brief overview, a method executed by a second communication device 512 (e.g., the wireless communication node 504) includes, at step 1002, preparing data for transmission, scheduling downlink resources at step 1004, sending DCI information at step 1006, transmitting a downlink transmission at step 1010, and determining if a retransmission should be performed at step 1016. Where the wireless communication node 504 determined that retransmission should be performed at step 1016, the wireless communication node 504 can proceed to executing said retransmission of one or more instances of the packet.

At step 1002, the wireless communication node 504 may prepare data for transmission. The preparation can include data segmentation, such as chunking data from a Packet Data Convergence Protocol (PDCP) layer into segments appropriate for transmission on the medium (e.g., PDSCH). Additionally, the data preparation can include generation of a header (e.g., a Radio Link Control [RLC] layer), channel coding, rate matching, modulation, resource element mapping, and so forth. Step 1002 can be initiated by either of the endpoint 502 or the wireless communication node 504. For example, the DL transmission can be initiated at the wireless communication node 504 or requested by the endpoint 502.

At step 1004, a scheduler 518 of the wireless communication node 504 may schedule downlink resources. For example, the scheduling may include evaluating channel conditions (e.g., as detected by a condition detection engine 522 at the wireless communication node 504), determining a resource block, selecting a modulation and coding scheme, and allocating a HARQ process.

At step 1006, the wireless communication node 504 may transmit DL Control Information (DCI) to the endpoint 502. The DCI may include, for example, resource block allocation, MCS, HARQ information, transport block size, and power control settings or other transmission parameters. The DCI may include scheduling information related a consecutive series of sub-frames (or slots thereof). The wireless communication node 504 can encode the DCI, to apply error correction coding, and map the encoded DCI to the PDCCH. The wireless communication node 504 may modulate the DCI (e.g., using QPSK modulation), insert control reference signals, and transmit the DCI over the PDCCH. A communication device 512 of endpoint 502 may receive the DCI from the wireless communications node at step 1008. The DCI can communicate a grant 520 from the wireless communication node 504 to the endpoint. In some instances, the grant 520 may be any of the various types discussed herein.

At step 1010, the wireless communication node 504 may transmit various duplicate packets of a data packet (sometimes referred to as instances of the data packet) generated by another endpoint 502 (e.g., a peer device or application server) to the communication device 512 of the endpoint device 502. More particularly, at step 1010A, the wireless communication node 504 may transmit a first instance of the data packet, at step 1010B, the wireless communication node 504 may transmit a second instance of the data packet, and at step 1010C, the wireless communication node 504 may transmit a third instance of the data packet. According to various implementations or conditions, the wireless communication node 504 may transmit additional or fewer instances of the packet.

At step 1012, the endpoint 502 may validate one or more instances of the data packet. For example, the validation may refer to conversion of a received signal into digital symbols according to a received MCS (e.g., as received from the wireless communication node 504). The endpoint 502 may estimate channel conditions using any received reference symbols, and extract or decode resource elements mapped to data bearing channels (e.g., the PDSCH). The validation can include an application of an error detection or correction technique (e.g., Turbo decoding in LTE or LDPC decoding in 5G) to detect and correct errors. Such detection or correction can include a determination of a CRC codeword which is compared to a reference value to determine a validity of the received packet.

A communication device 512 of the endpoint 502 can perform the validation for each of the received packets. That is, the communication device 512 can perform at least a portion of the validation separately for each packet. For example, at step 1012A, the endpoint 502 communication device 512 may validate the packet transmitted at step 1010A; at step 1012B, the endpoint 502 communication device 512 may validate the packet transmitted at step 1010B; and at step 1012C, the endpoint 502 communication device 512 may validate the packet transmitted at step 1010C. The communication device 512 may perform the validations of the various instances transparently, to other components of the endpoint 502, reducing overhead and complexity of upper levels of a stack implementation. In some embodiments, the validation can be performed based on data from multiple packets. For example, the validation can include assembling RLC data and comparing sequence numbers for sequential packets. For example, a dropped packet having a sequence number of 0x0002 can be detected according to a detection of a packet having a sequence number 0x0001 and a subsequent packet of 0x0003.

At step 1014, the endpoint 502 may acknowledge one or more of the received packets. This acknowledgement may refer to either of a positive acknowledgement (ACK) or negative acknowledgement (NACK). In some cases, the positive acknowledgement (ACK) may be referred to as an acknowledgment. For example, references to an “acknowledgement and/or negative acknowledgement” should be construed as referring to an ACK and/or a NACK. As for step 1010, the communication device 512 of the endpoint may perform the acknowledgement of the various instances transparently to other components of the endpoint 502, reducing overhead and complexity of upper levels of a stack implementation. Step 1014 may be performed according to a single transmission for each of the duplicate packets, or according to separate transmissions (e.g., corresponding to step 1014A, step 1014B, and step 1014C).

At step 1016, a communication device 512 of the wireless communication node 504 may receive the one or more acknowledgments from the endpoint 502. In some embodiments, the communication device 512 of the wireless communication node 504 receives multiple acknowledgements and determines whether a retransmission should be performed. For example, the communication device 512 of the wireless communication node 504 may, operating transparently to upper layers of a networking stack (e.g., at a PHY level), logically OR and received ACKS, and proceed to a further step to execute retransmission where no ACKS are received. For example, for duplicate TCP messages, with zero received ACKS, the communication device 512 of the wireless communication node 504 may proceed to executing the transmission. For UDP messaging, or where at least one ACK is received, the communication device 512 of the wireless communication node 504 can proceed to awaiting any subsequent packets.

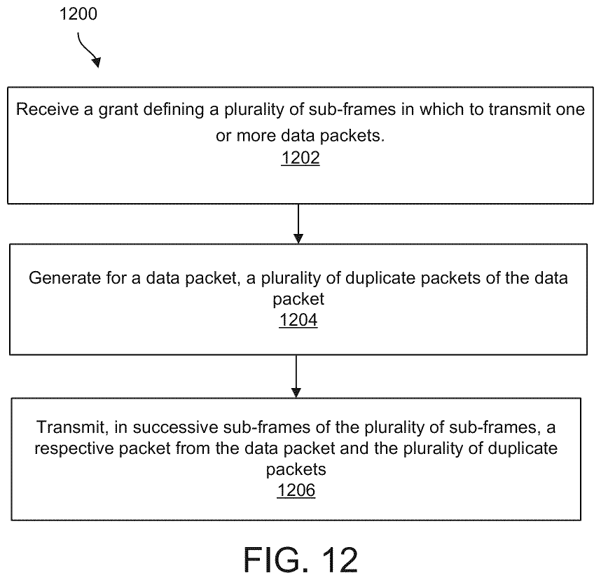

Referring now to FIG. 11, a flowchart showing an example method 1100 of downlink communication is provided, according to an example implementation of the present disclosure. Corresponding portions of the method 1100 may be executed, performed, or otherwise implemented on or related to corresponding communication devices 512 (e.g., a communication device 512 of an endpoint 502 and a communication device of a wireless communication nodes 504). Accordingly, the depicted method 1100 may be described as a first method executed, performed, or otherwise implemented by an endpoint 502 (e.g., a communication device 512 thereof), and a second method executed, performed, or otherwise implemented by a wireless communication node 504 (e.g., a communication device 512 or scheduler 518 thereof). Various suboperations of the method 1000 of FIG. 10 can be incorporated into the present method, and are not repeated to aid with the brevity of the present disclosure. Also, some operations may be performed invertedly (e.g., by a party of the endpoint 502 rather than of the wireless communication node 504 and a counterparty of the wireless communication node 504 rather than of the endpoint 502). Moreover, various suboperations of the method 1000 of FIG. 10 or the present method 1100 may likewise be incorporated into the method 1200 of FIG. 12, along with other aspects of the present disclosure.

As a brief overview, a method executed by a first communication device 512 (e.g., the endpoint 502) includes, at step 1102, providing a scheduling request (SR); receiving a UL grant 520 at step 1108; providing an UL transmission at step 1110; and determining whether retransmission should be performed at step 1116.

As a brief overview, a method executed by a second communication device 512 (e.g., the wireless communication node 504) includes, at step 1104, receiving the SR of step 1102; issuing an UL grant 520 at step 1106; validating the data of step 1110 at step 1112; and providing an acknowledgement of the validation at step 1114.

At step 1102, the endpoint 502 may provide a SR. Incident to the SR (prior or subsequent thereto), the endpoint 502 can prepare data for transmission, as referred to above with regard to step 1002 of the method 1000 of FIG. 10. At step 1104, the communication device 512 of the wireless communication node 504 receives the SR of step 1102, and may provide the SR to a scheduler 518 or other component of a networking stack. At step 1106, the communication device 512 of the wireless communication node 504 sends an UL grant 520 to the communication device 512 of the endpoint 502 (e.g., as received from the scheduler 518). At step 1108, the communication device 512 of the endpoint 502 receives the UL grant 520, and sends multiple duplicate instances of a packet (e.g., as described above with regard to the transmission of various duplicate packets of step 1010 of the method 1000 FIG. 10). The communication device 512 of the endpoint 502 can use a PUSCH, rather than the (PDSCH) of step 1010 for the transmission. More particularly, at step 1110A, the wireless communication node 504 of the endpoint 502 may transmit a first instance of the data packet, at step 1110B, the communication device 512 of the endpoint 502 may transmit a second instance of the data packet, and at step 1110C, the communication device 512 may transmit a third instance of the data packet.

At step 1112, the communication device 512 of the wireless communication node 504 validates the various duplicated packets to determine if they include valid (e.g., correct or correctable) payload data, as described above with regard to step 1012, and proceeds to acknowledge (e.g., ACK or NACK) at least one of the duplicate packets are referred to above with regard to step 1014 of the method 1000 of FIG. 10. For example, as for the method 1000 of FIG. 10, acknowledges may be provided separately, as consolidated, or as logically OR′d, for validations performed at step 1112A, step 1112B, and step 1112C. For example, as depicted, the acknowledgments provided to the endpoint 502 from the wireless communications node 504 can include a first ACK or NACK at step 1114A, a second ACK or NACK at step 1114B, and a third ACK or NACK at step 1114C. At step 1116, the communication device 512 of the endpoint 502 determines whether retransmission should occur, as described above with regard to step 1116, and may proceed to retransmit the packet subsequent to a determination that retransmission should occur, or proceed to subsequent packets responsive to a determination that retransmission should not occur (e.g., responsive to one or more received ACKS at step 1114).

Referring now to FIG. 12, a flowchart showing an example method 1200 is provided, according to an example implementation of the present disclosure. Corresponding portions of the method 1200 may be executed, performed, or otherwise implemented by an endpoint 502 or other communication device 512 in communicative connection with a wireless communication node 504. As a brief overview, the method 1200 includes, at step 1202, receiving a grant defining a plurality of sub-frames in which to transmit one or more data packets. The method 1200 may include generating, for a data packet, a plurality of duplicate packets of the data packet at step 1204. The method 1200 may include transmitting, in successive sub-frames of the plurality of sub-frames, a respective packet from the data packet and the plurality of duplicate packets at step 1206.

At step 1202, the communication device 512 receives a grant 520 from a wireless communication node 504 defining a plurality of sub-frames in which to transmit one or more data packets. For example, the grant 520 can include an uplink grant 520 or a downlink grant 520.

At step 1204, the communication device 512 generates, for a data packet, a plurality of duplicate packets of the data packet. In some embodiments, the plurality of duplicate packets may be generated at a PHY of the communication device transparent to other layers of the communication device 512. The communication device 512 (e.g., a PHY of the communication device 512) can be configured to determine to generate the duplicate packets based on a network condition, a condition of the communication device 512, or a service supported by the communication device 512 satisfying a selection criterion. For example, the network condition can include at least one of a count of negative acknowledgements received from the wireless communication node 504, a received signal strength (e.g., for a communications link between the communication device 512 and the wireless communication node 504), or a throughput (e.g., a number of packets or data per time interval). The condition of the communication device 512 can include at least one of a location of the communication device 512, or a movement metric of the communication device 512. The one or more services may correspond to generation of latency-sensitive traffic for transmission by the communication device 512 to the wireless communication node 504.

The communication device can adjust a quantity of the duplicate packets based on the condition of the network, communication device 512, or the services. Accordingly, the communication device 512 can generate the duplicate packets for some conditions and omit the generation of the duplicate packets for other conditions. For example, the communication device 512 can generate duplicate packets (e.g., at the PHY level) for multiple data packets received from another level of a communications stack, for some of various data packets received from the other level of a communications stack, and omit such generation for other packets enqueued for transmission.

At step 1206, the communication device transmits, in successive (e.g., contiguous) sub-frames of the plurality of sub-frames, a respective packet from the data packet and the plurality of duplicate packets. As indicated above, with regard to step 1204, the transmissions can include respective packets from the multiple data packets and the corresponding respective duplicate packets. Likewise, the transmissions can omit or include differing quantities of the respective duplicate packets according to various conditions related to a device, network, or service.

Responsive to the transmission of the various duplicate packets, the communication device 512 can receive, from the wireless communication node 504, for one of the respective packets, an acknowledgement or negative acknowledgement, wherein the acknowledgement or the negative acknowledgement corresponds to the data packet. For example, where the communication device transmits duplicate packets for multiple data packets, the respective acknowledgement or negative acknowledgement for the data packets may be received in one or more second sub-frames subsequent to the plurality of first sub-frames (e.g., the respective acknowledgement or negative acknowledgement for the data packets may be received in a single sub-frame subsequent to the transmission sub-frames).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled”, and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a communication device, a grant from a wireless communication node, defining a plurality of sub-frames in which to transmit one or more data packets;
generating, by the communication device, for a data packet, a plurality of duplicate packets of the data packet; and
transmitting, by the communication device, in successive sub-frames of the plurality of sub-frames, a respective packet from the data packet and the plurality of duplicate packets.

2. The method of claim 1, further comprising:
determining, by the communication device, to generate the plurality of duplicate packets, based on a network condition of the communication device satisfying a selection criterion.

3. The method of claim 2, wherein the network condition comprises at least one of a count of negative acknowledgements received from the wireless communication node, a received signal strength, or a throughput.

4. The method of claim 1, further comprising:
determining, by the communication device, to generate the plurality of duplicate packets, based on at least one of a condition of the communication device or one or more services supported by the communication device.

5. The method of claim 4, wherein the condition of the communication device comprises at least one of a location of the communication device or a movement metric of the communication device.

6. The method of claim 4, wherein the one or more services correspond to generation of latency-sensitive traffic for transmission by the communication device to the wireless communication node.

7. The method of claim 1, further comprising:
receiving, by the communication device from the wireless communication node, for one of the respective packets, an acknowledgement or negative acknowledgement, wherein the acknowledgement or the negative acknowledgement corresponds to the data packet.

8. The method of claim 1, further comprising:
generating, by the communication device, for a plurality of data packets including the data packet, a plurality of respective duplicate packets for each of the plurality of data packets; and
transmitting, by the communication device, in the successive sub-frames of the plurality of sub-frames, respective packets from the plurality of data packets and the plurality of respective duplicate packets.

9. The method of claim 8, further comprising:
receiving, by the communication device from the wireless communication node, for one of the respective packets, a respective acknowledgement or negative acknowledgement, wherein the respective acknowledgement or the negative acknowledgement corresponds to the data packet of the plurality of data packets.

10. The method of claim 9, wherein the plurality of sub-frames comprise a plurality of first sub-frames, and wherein the respective acknowledgement or negative acknowledgement for the plurality of data packets is received in a plurality of second sub-frames subsequent to the plurality of first sub-frames.

11. The method of claim 9, wherein the respective acknowledgement or negative acknowledgement for the plurality of data packets is received in a single sub-frame subsequent to the plurality of sub-frames.

12. The method of claim 1, wherein the grant comprises at least one of a downlink grant or an uplink grant.

13. A wireless communication endpoint, comprising:
a communication device configured to:
receive a grant from a wireless communication node, defining a plurality of sub-frames in which to transmit one or more data packets;
generate, for a data packet, a plurality of duplicate packets of the data packet; and
transmit, in successive sub-frames of the plurality of sub-frames, a respective packet from the data packet and the plurality of duplicate packets.

14. The wireless communication endpoint of claim 13, wherein the communication device is further configured to:
determine to generate the plurality of duplicate packets, based on a network condition of the communication device satisfying a selection criterion, wherein the network condition comprises at least one of a count of negative acknowledgements received from the wireless communication node, a received signal strength, or a throughput.

15. The wireless communication endpoint of claim 13, wherein the communication device is further configured to:
determine to generate the plurality of duplicate packets, based on at least one of a condition of the communication device or one or more services supported by the communication device,
wherein the condition of the communication device comprises at least one of a location of the communication device or a movement metric of the communication device, and
wherein the one or more services correspond to generation of latency-sensitive traffic for transmission by the communication device to the wireless communication node.

16. The wireless communication endpoint of claim 13, wherein the communication device is further configured to:
receive, from the wireless communication node, for one of the respective packets, an acknowledgement or negative acknowledgement, wherein the acknowledgement or the negative acknowledgement corresponds to the data packet.

17. The wireless communication endpoint of claim 13, wherein the communication device is further configured to:
generate, for a plurality of data packets including the data packet, a plurality of respective duplicate packets for each of the plurality of data packets; and
transmit in the successive sub-frames of the plurality of sub-frames, respective packets from the plurality of data packets and the plurality of respective duplicate packets.

18. The wireless communication endpoint of claim 13, wherein the communication device is further configured to:
receive, from the wireless communication node, for one of the respective packets, a respective acknowledgement or negative acknowledgement, wherein the respective acknowledgement or the negative acknowledgement corresponds to the data packet of the plurality of data packets,
wherein the plurality of sub-frames comprise a plurality of first sub-frames, and the respective acknowledgement or negative acknowledgement for the plurality of data packets is received in a plurality of second sub-frames subsequent to the plurality of first sub-frames, or
wherein the respective acknowledgement or negative acknowledgement for the plurality of data packets is received in a single sub-frame subsequent to the plurality of sub-frames.

19. The wireless communication endpoint of claim 13, wherein the grant comprises at least one of a downlink grant or an uplink grant.

20. A non-transitory computer readable medium storing instructions that, when executed by one or more processors, cause the one or more processors to:
receive a grant from a wireless communication node, defining a plurality of sub-frames in which to transmit one or more data packets;
generate, for a data packet, a plurality of duplicate packets of the data packet; and
transmit, in successive sub-frames of the plurality of sub-frames, a respective packet from the data packet and the plurality of duplicate packets.
